(19) United States
(12) Patent Application Publication
(10) Pub. No.: US 2005/0216487 A1
(43) Pub. Date: Sep. 29, 2005

(54) System and method for generating tasks related to electronic image files

(75) Inventors: Lisa M. Fisher, Easton, MA (US); Richard M. Armand, Danvers, MA (US); Robert A. Costa, Fairhaven, MA (US); John R. Ferguson, Concord, MA (US)

Correspondence Address: DOWNS RACHLIN MARTIN PLLC, 199 MAIN STREET, P O BOX 190, BURLINGTON, VT, 05402-0190, US

(73) Assignee: IDX Investment Corporation, Burlington, VT (US)

(21) Appl. No.: 10/810,214

(22) Filed: Mar. 26, 2004

(51) Int. Cl. G06F 17/00

(52) U.S. Cl. 707/100

(57) ABSTRACT

A system (20) for generating tasks related to electronic image files. System (20) includes an electronic document manager (EDM) (22) that is in communication with a task engine (24). EDM (22) receives electronic image file (EIF) batches (26) generated by a scanning device application (28) and scanning device (30) and third-party generated EIF batches (32). As discussed further below, EDM (22) shares information derived from EIF batches (26) and (32) with task engine (24). In turn, task engine (24) generates EIF-related tasks. Another aspect is a method (170) that sorts or filters the electronic image files stored in EIF database (80) and returns either a list or images of the sorted or filtered files to first portion (120) of graphical user interface (90) for display to a user. Another aspect is a method (180) of generating tasks related to electronic image files.

### FIELD OF THE INVENTION

The present invention generally relates to electronic document management systems, which are used to manage electronic image files. In particular, the present invention is directed to a system and method for generating tasks related to electronic image files.

### BACKGROUND OF THE INVENTION

In order to manage the volume of data in integrated delivery networks (IDN), healthcare provider organizations have turned to sophisticated data management systems or applications. Typically, these systems include modules for maintaining or improving the quality of data. By improving the quality of data, i.e., correcting errors and/or omissions in data, the revenue cycle for patient billing may be reduced and the overall service to customers may be improved. Generally, for each healthcare service provider in the IDN, a task list is developed and populated with tasks for improving data specific to that particular provider. A user such as a data clerk is often responsible for working the tasks that populate the task lists.

For large IDNs, the tasks that populate the task lists may include tasks input by users of the system, tasks input by third party systems, and tasks generated by the data management system itself. Prior art data management systems typically are not capable of integrating tasks that specifically relate to electronic image files, e.g., image files generated by scanning, created using graphics software, or imported from other applications, etc. An example of a task that specifically relates to an electronic image file is a task that is generated when an insurance card is scanned. Typically, a patient insurance card is scanned when a patient checks in for an appointment at a hospital, clinic or doctor's office. However, the electronic image file that contains the insurance card information is typically needed by billers and registration personnel to verify coverage—not usually the person checking in the patient. Prior art data management systems are not capable of generating a task, which typically includes instructions or workflow for working the task and a link to the particular electronic image file. For example, in the case of a scanned insurance card, prior art systems are not capable of generating a task instructing the appropriate personnel to verify the information contained in the patient insurance card and providing a link to the electronic image file of the insurance card.

In prior art systems, manual processes are typically utilized for notifying the correct personnel when electronic image files become available. Unfortunately, manual processes typically break down and may result in electronic image files not being properly indexed or indexed in a timely manner. The failure to provide the information contained in the electronic image files to the appropriate input points within an organization in a timely manner often results in billing delays, payment delays, and an overall increase in the revenue cycle time.

The healthcare industry is but one example of where the system and method for generating tasks related to electronic image files of the present invention may be utilized. As those skilled in the art are aware, both electronic document managers and task engines are used in myriad applications and industries.

### SUMMARY OF THE INVENTION

One aspect of the present invention is a system for generating one or more tasks related to one or more electronic image files. The system includes an electronic document manager including an electronic image file database for storing the electronic image files and an electronic image file event generator for generating electronic image file events related to the electronic image files, and a task engine in communication with the electronic document management module for generating tasks related to the electronic image files based on the contents of the electronic image file events.

Another aspect of the present invention is a method of generating one or more tasks related to one or more electronic image files stored in an electronic document manager. The method includes the following steps: creating one or more electronic image file events related to the electronic image files; providing a predetermined set of rules, each of the rules having at least one predetermined condition; comparing the one or more electronic image file events to the predetermined set of rules; and creating one or more tasks if the one or more electronic image file events meets the at least one predetermined condition.

Still another aspect of the present invention is a system for generating one or more tasks related to one or more electronic image files. The system includes an electronic document management module including an electronic image file database for storing the electronic image files and an electronic image file event generator submodule for generating electronic image file events related to the electronic image files, and a task engine module in communication with the electronic document management module for generating tasks related to the electronic image files based on the contents of the electronic image file events. The task engine module includes a task generation submodule including an event manager for storing the electronic image file events and a ruleset manager including at least one predetermined set of rules. Each of the rules has at least one predetermined condition. The task engine module also includes a task generation manager for comparing the electronic image file events to the at least one predetermined set of rules and generating one or more tasks if the electronic image file events meet the at least one predetermined condition.

Yet another aspect of the present invention is a computer readable medium in which is contained a program generating one or more tasks related to one or more electronic image files stored in an electronic document manager, the program comprising instructions that, when executed by a computer, perform the following steps: creating one or more electronic image file events related to the electronic image files; providing a predetermined set of rules, each of the rules having at least one predetermined condition; comparing the one or more electronic image file events to the predetermined set of rules; and creating one or more tasks if the one or more electronic image file events meets the at least one predetermined condition.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is a simplified schematic diagram of a computer system for accessing the system according to one embodiment of the present invention;

FIG. 2 is a schematic diagram of the system according to one embodiment of the present invention;

FIG. 3 is a schematic diagram of the system including a task generation submodule according to one embodiment of the present invention;

FIG. 4 is a schematic diagram of a graphical user interface according to one embodiment of the present invention;

FIG. 5 is a schematic diagram of a graphical user interface according to one embodiment of the present invention;

FIG. 6 is a schematic diagram of a graphical user interface according to one embodiment of the present invention;

FIG. 7 is a flow chart of a method for sorting or filtering electronic image files according to one embodiment of the present invention; and

FIG. 8 is a flow chart of a process for generating tasks by the system according to one embodiment of the present invention.

### DETAILED DESCRIPTION OF THE DRAWINGS

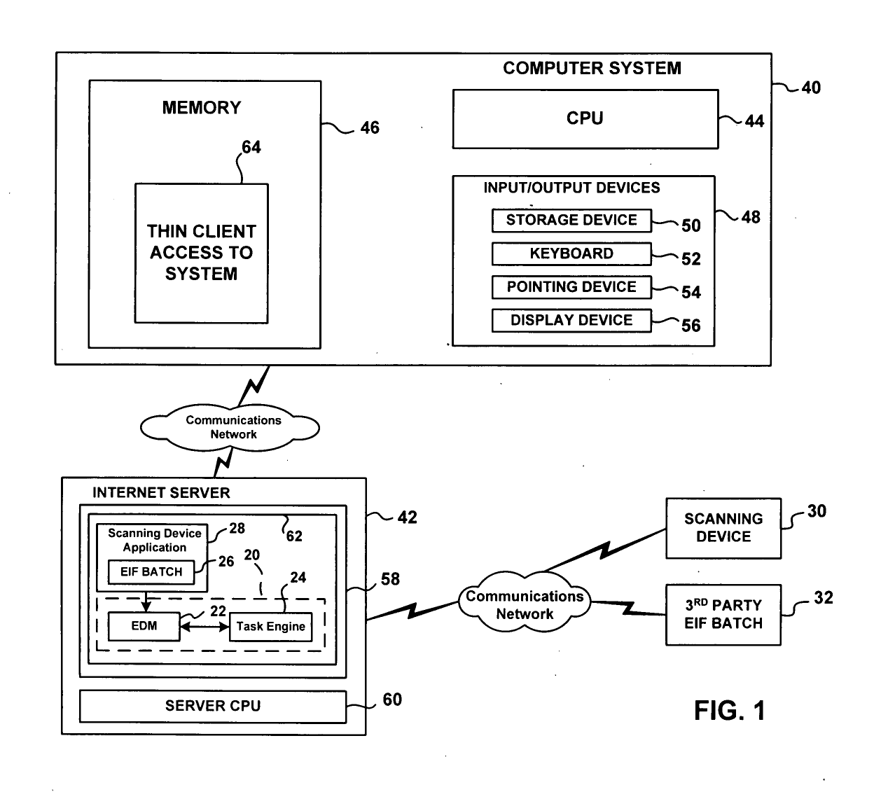

Referring now to the drawings in which like reference numerals indicate like parts, and in particular to FIG. 1, one aspect of the present invention is a system 20 for generating tasks related to electronic image files. System 20 includes an electronic document manager (EDM) 22 that is in communication with a task engine 24. As one aspect of its functionality, EDM 22 receives electronic image file (EIF) batches 26 generated by a scanning device application 28 and scanning device 30 and/or EIF batches 32 generated by a third-party such as an electronic document clearinghouse. Generally, EIF batches 26 and 32 include one or more electronic image files in a standard EIF format, e.g., jpg, tiff, bmp, gif, pdf, png, xpm. Examples of electronic image files include patient insurance cards, claims forms, billing invoices, clinical records, and test records such as x-rays. As discussed further below, EDM 22 shares information derived from EIF batches 26 and 32 with task engine 24. In turn, task engine 24 generates EIF-related tasks or tasks related to the one or more electronic image files included in batches 26 and 32.

FIG. 1 illustrates system 20 as being implemented in an appropriate computing environment. Although not required, the invention will be described generally in terms of computer-executable instructions, typically included in program modules, that are executed by a conventional, general purpose, digital computer. Typically, program modules include routines, programs, objects, components, data structures, etc. that perform specific tasks. The invention may be practiced with a variety of computer system configurations, including networked client-server computing systems, hand-held devices, programmable consumer electronics, minicomputers, mainframe computers, and the like. The invention will typically, but not necessarily, be practiced in distributed computing environments where tasks are performed by remote processing devices that are linked through a communications network, e.g., a LAN, WAN or an Internet-based network. In a distributed computing environment, program modules may be located in both local and remote memory storage devices.

It is contemplated that system 20 of the present invention will operate in a networked computing environment including a personal computer 40 and an Internet server 42. Personal computer 40 may include a computer central processing unit (CPU) 44, a computer memory 46, and input/output devices 48. Input/output devices 48 typically include a storage device 50, such as a hard disk drive, a keyboard 52, a pointing device 54, i.e., a mouse, and a display device 56, such as a monitor.

Internet server 42 may include a server memory 58 and an Internet server CPU 60. Generally, system 20 includes one or more computer programs 62 that reside in server memory 58 of Internet server 42. Of course, computer programs 62 may reside in the memory of a local or wide area network server or in the memory of an individual desktop computer system.

In one implementation, system 20 may be accessed via a thin client access program 64 that resides in computer memory 46 of computer system 40. In such a configuration, computer programs 62 may be executed on either or both Internet server CPU 60 and computer CPU 44.

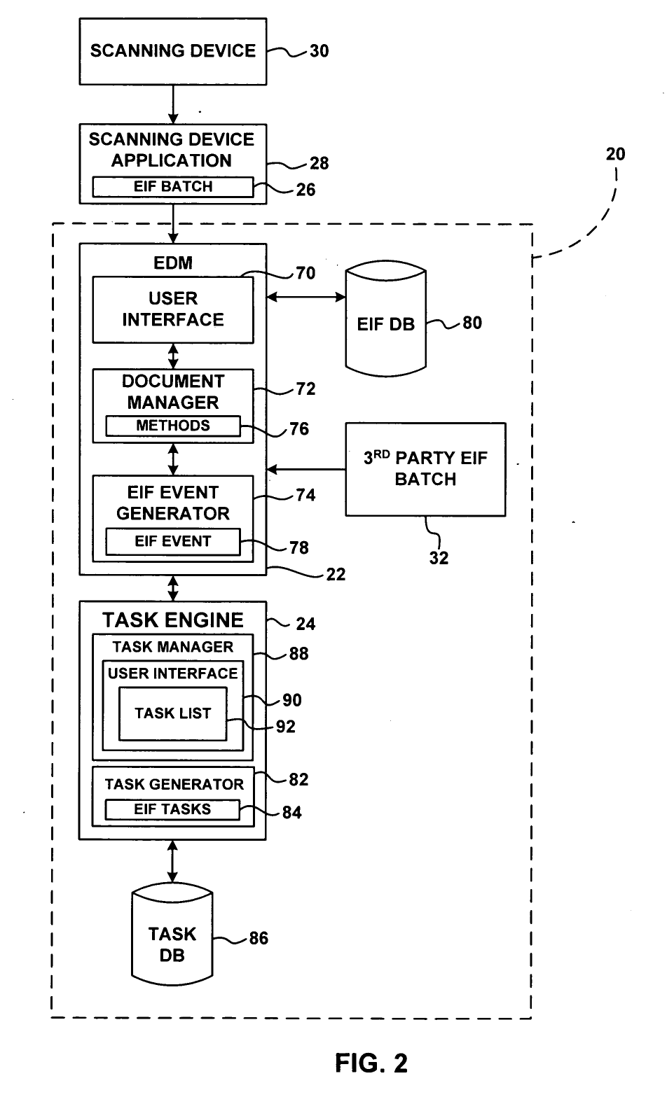

Referring now to FIG. 2, in one embodiment, EDM 22 may include a user interface 70, a document manager submodule 72, and an EIF event generator 74. User interface 70 allows a user to interact with both document manager submodule 72 and EIF event generator 74. As discussed further below, document manager submodule 72 may include one or more methods 76 for sorting and filtering the electronic image files (not shown) included in EIF batches 26 and 32. As mentioned above, EIF batches 26 and 32 generally include one or more electronic document files. EIF batch 26 includes electronic document files generated by scanning device 30 and scanning device application 28 and electronic document files generated by any third-party source, which may include a second scanning device or an electronic document clearinghouse. As also discussed further below, EIF event generator 74 generates EIF events 78 for each electronic image file based on information included in EIF batches 26 and 32. EDM 22 typically communicates with an EIF database 80 for storing the electronic image files transmitted with batches 26 and 32. EDM 22 may be used to manage all types of electronic files, i.e., both image files and non-image files. As follows, EIF database 80 may also include non-image electronic files such as word processing files or other electronic documents.

As mentioned above, EDM 22 is in communication with task engine 24. EIF events 78 are transmitted from EDM 22 to task engine 24, requests to view electronic image files or to call methods 76 stored in document manager 72 of the EDM are transmitted from the task engine to the EDM, and electronic image files from EIF database 80 are shared with and viewed within the task engine environment. Task engine 24 typically includes a task generation submodule 82 for creating EIF-related tasks 84 based on the information in EIF events 78. Task engine 24 may include a task manager submodule 88 having a graphical user interface (GUI) 90 for viewing a task list 92 including both EIF-related tasks 84 and non-EIF-related tasks. Task engine 24 typically communicates with a task database 86, which is used to store the tasks that populate task list 92.

In use, system 20 typically will work seamlessly to integrate EDM 22 with task engine 24. EDM 22 receives EIF batches 26 that contain one or more electronic image files (not shown) created using scanning device 30 and scanning device application 28 or EIF batches 32 containing one or more electronic image files (not shown) created by a third party such as an electronic document clearinghouse. EDM 22 stores the electronic image files in EIF database 80. EIF event generator 74 generates an EIF event 78 for each electronic image file that is stored in EIF database 80 based on data included in batch 26 or 32. EIF event generator 74 may also generates an EIF event 78 for each existing electronic image file stored in EIF database 80 that is modified. An EIF event 78 is a data file that includes various data regarding the electronic image file such as the image file type, image size, and any pertinent data fields related to the subject of the image file. Each EIF event 78 is forwarded to task engine 24. Within task engine 24, each EIF event 78 is processed by task generator submodule 82 to determine whether a task related to the event should be generated. Although not illustrated in FIG. 2, task engine 24 may include a set of predetermined rules that are compared to each EIF event 78 to determine whether to generate a corresponding task. If it is determined that a task should be generated, EIF task 84 is generated and stored in task database 86. The tasks stored in task database 86 populate task list 92. Users accessing task list 92 in task engine 24 are thus able to both view and work EIF tasks 84. As discussed further below, task engine 24 typically includes links or buttons that call methods 76 from EDM document manager 72. Methods 76 generally sort or filter electronic image files stored in database 80 and return them to GUI 90 for viewing by a user. For example, while working an EIF task 84, a user is typically able to view the electronic image file underlying the task by simply clicking on a link or button with pointing device 54.

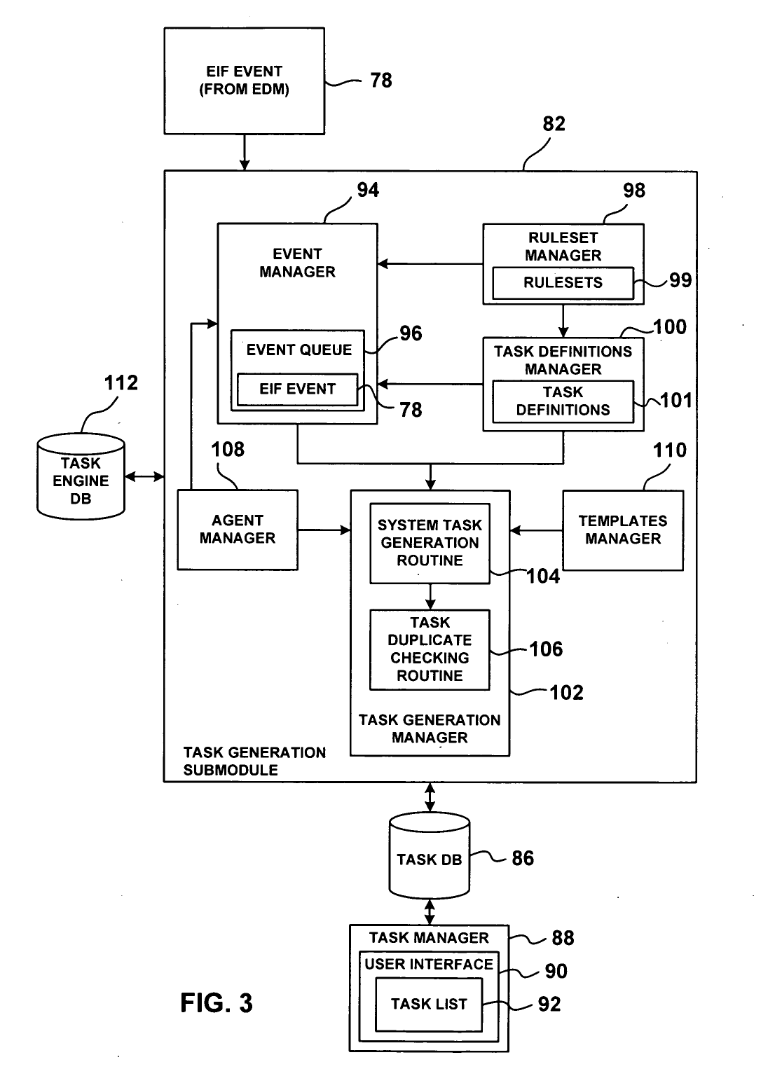

As illustrated in FIG. 3, in one embodiment, task generation submodule 82 of system 20 includes a plurality of manager submodules that interact to generate tasks: an event manager 94 having an event queue 96 for receiving EIF events 78; a ruleset manager 98; a task definitions manager 100; a task generation manager 102 having a system task generation routine 104 and a task duplicate checking routine 106; an agent manager 108; and a templates manager 110. In addition to the disclosure contained herein, pending U.S. patent application Ser. No. 10/632,328, filed Aug. 1, 2003, which is hereby incorporated by reference in its entirety, further describes the embodiment of task generation submodule 82 illustrated in FIG. 3.

Ruleset manager 98 supplies task generation rulesets 99 to both event manager 94 and task definitions manager 100. Task definitions manager 100 supplies task definitions 101 to event manager 94. Information is sent from event manager 94 and task definitions manager 100 to task generation manager 102 where system task generation routine 104 generates tasks using data supplied by templates manager 110. Alternatively, information may be sent from agent manager 108 to task generation manager 102 instead of from event manager 94 and task definitions manager 100. In addition, agent manager 108 may place events directly on event queue 96. Before sending tasks to task database 86, tasks generated by system task generation routine 104 are checked by task duplicate checking routine 106 to determine if identical tasks exist in the system. As discussed further below, acceptable tasks are generally stored in task database 86 for viewing in task list 92 via task manager submodule 88 and GUI 90. The data that populates the managers in task generation submodule 82 is typically provided by a task engine database 112, which is generally populated based on setup input from a system administrator. Much of the data stored in task engine database 112 is grouped in dictionaries. For example, one dictionary may exist for task names and another for views.

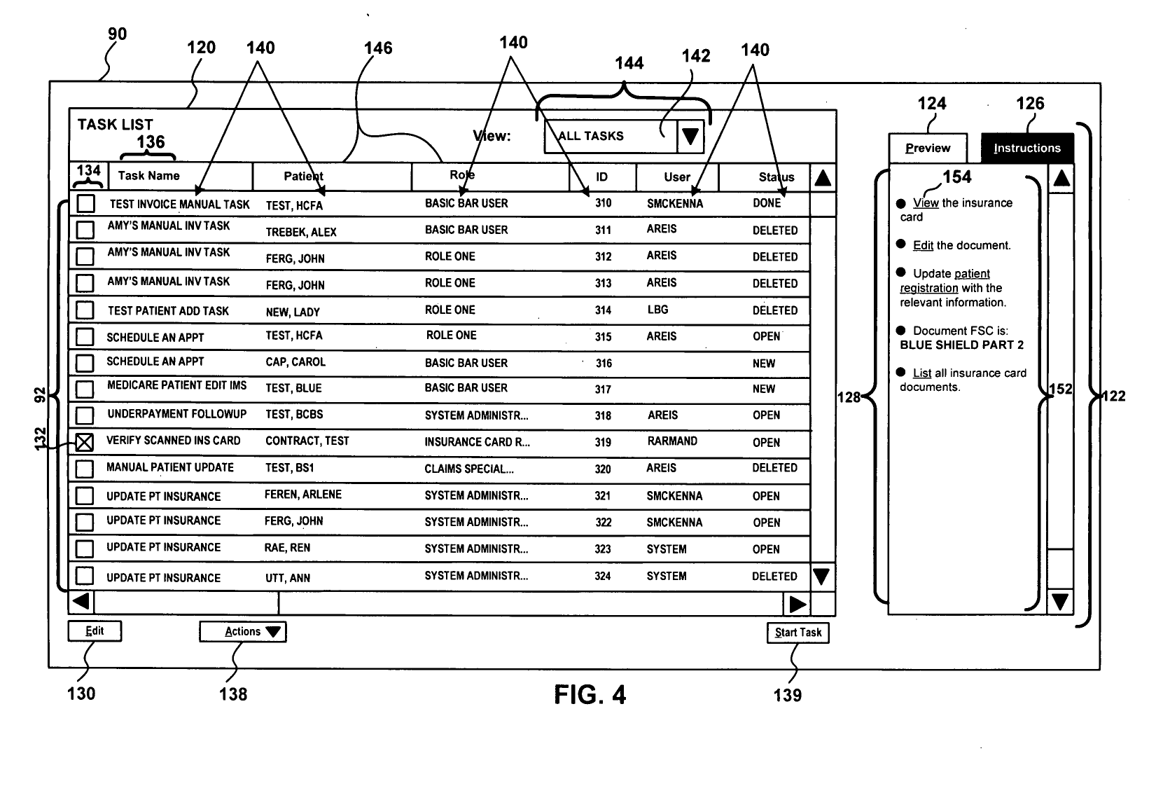

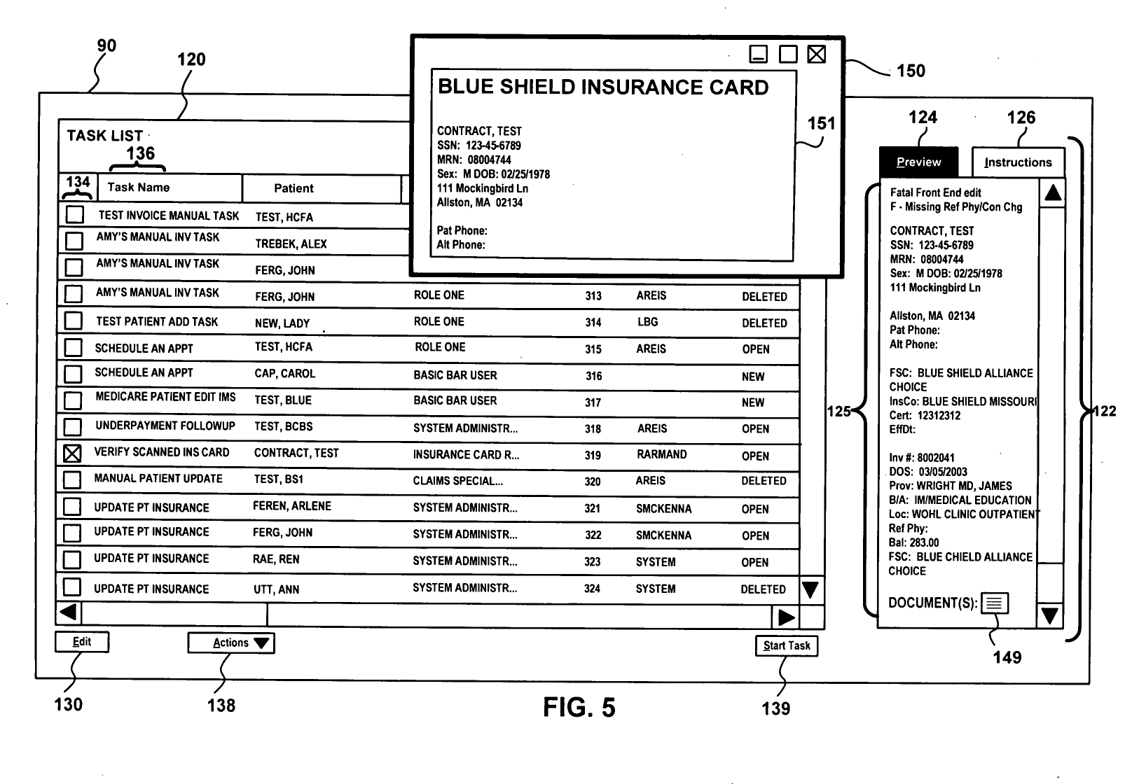

A user typically interacts with task manager submodule 88 to view and work EIF-related tasks 84 included on task list 92. As also described above, task list 92 is displayed to a user via GUI 90. Referring now to FIGS. 4-6, in one embodiment, GUI 90 may include a first portion 120 and a second portion 122. First portion 120 includes task list 92. Second portion 122 includes a preview tab 124 and a corresponding preview text box 125 (shown in FIG. 5), and an instructions tab 126 and a corresponding instructions text box 128. Of course, in other embodiments, additional tabs may be included. In addition, any type of data, link, or instruction may be included in each tab. A plurality of buttons facilitates user interaction with task list 92. An edit button 130 allows a user to edit a selected task 132. In FIG. 4, only one task, selected task 132, is selected as denoted by the “X” in task selection column 134 to the left of “Task Name” column 136. However, a user may select a plurality of tasks for viewing and or working by marking the box in task selection column 134 for each task desired. An actions button 138 allows a user to select actions from a dropdown menu (not shown) having predefined actions for working common tasks. Examples of predefined actions include but are not limited to hiding preview or instructions tabs 124 and 126, respectively, viewing selected tasks, manually marking tasks as done, reassigning tasks, and adding notes to tasks. A start task button 139 allows a user to begin working a selected task 132, which may be EIF-related task 84.

Task list 92 generally includes a plurality of data columns 140 that include data related to a particular task. The particular data columns included in data columns 140 are determined according to a particularly selected view 142 that is selected from a view dropdown box 144. Particularly selected view 142 causes system 20 to run a query against task database 86. The tasks that match the view query are displayed on task list 92. In addition to data from task database 86, data from sources outside of task database 86, e.g., data from a target object, may be included in task list 92. A system administrator, using task engine module 24, creates the views that populate view dropdown box 144. A user may typically access any views included in view dropdown box 144. After selecting a view, a user may alter selected view 142 by selecting a particular column header 146 thereby sorting task list 92 according to the data contained in the column beneath the selected header column.

Referring now to FIG. 5, preview tab 124 and corresponding preview text box 125 allow a user to view additional data related to any of the tasks in task list 92. Typically, a user highlights a particular task using pointing device 54 to designate it as the presently selected task (not shown). Data related to the presently selected task populates preview text box 125. In this way, a significant amount of data may be displayed with respect to each task in task list 92. In addition to data, preview text box 125 may also include links or buttons that cause additional data or electronic image files related to the presently selected task to be displayed. For example, in the embodiment illustrated in FIG. 5, preview text box 125 includes a documents button 149, which allows a user to cause a list of all electronic image filenames related to the subject of the presently selected task, or the files themselves, to be displayed in either first portion 120 or a pop-up window 150. In FIG. 5, an insurance card 151 of the particular patient, i.e., an electronic image file stored in EIF database 80, is displayed in pop-up window 150.

As mentioned above, to begin working a task, a user may select start task button 139 or select instructions tab 126. Selection of start task button 139 or instructions tab 126 causes the instructions tab to be selected thereby simultaneously displaying instructions text box 128 (as illustrated in FIG. 4) and hiding preview text box 125. In one embodiment, selection of start task button 139 may also cause the first item in instructions text box 128 to be executed. Instructions text box 128 typically includes a list of options 152 for working the presently selected task. Referring again to FIG. 4, list of options 152 may not be numbered or arranged in a particular order. However, in other embodiments, list of options 152 may be numbered or arranged in a particular order. In addition, in some instances, a task may only be informational and no instructions will be provided. List of options 152 may also include various links or buttons that allow a user to cause additional data or electronic image files to be displayed in first portion 120. For example, in FIG. 4, list of options 152 includes a view link 154. When selected, view link 154 causes an electronic image of the insurance card of the subject of the presently selected task, i.e., a particular patient—“TEST CONTRACT,” to be displayed (as illustrated in FIG. 5) in first portion 120. As mentioned above, in one embodiment, selection of start task button 139 may cause view link 154 to be automatically selected.

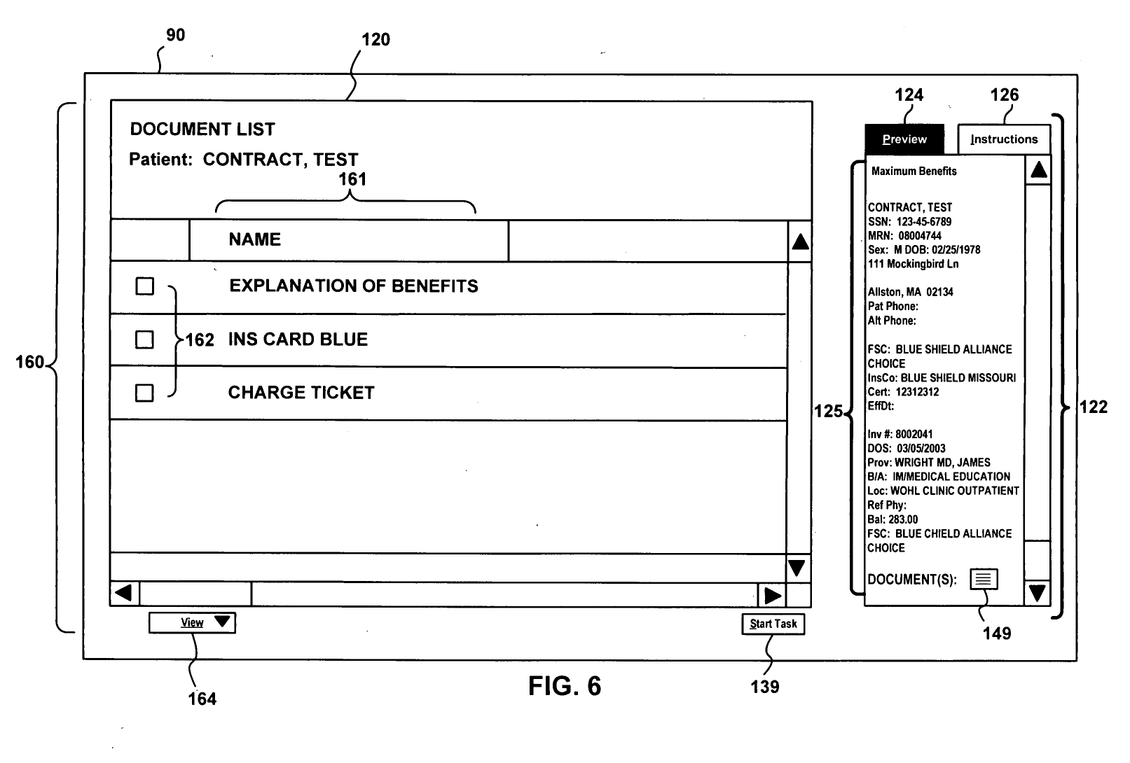

Referring now to FIG. 6, as mentioned above with respect to FIG. 5, upon selection of documents button 149, an electronic document list 160 may be displayed in first portion 120. List 160 generally includes a name column 161 with descriptive names of all the electronic image files stored in system EIF database 80 that relate to the subject of the presently selected task, i.e., the patient “TEST CONTRACT,” in this example. List 160 may include selection boxes 162 for each electronic image file and a view button 164. A user may view any of the electronic image files from list 160 in first portion 120 by checking any of selection boxes 162 and selecting view button 164.

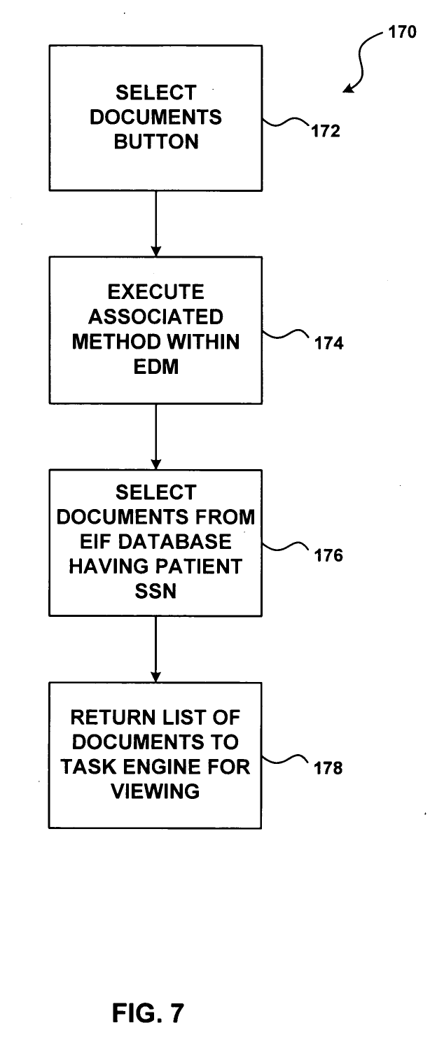

As mentioned above, when selecting a button or a link such as documents button 149 or view link 154, a particular one of methods 76 in EDM 22 is called. Generally, each of methods 76 may be a query that sorts or filters the electronic image files stored in EIF database 80 and returns either a list or images of the sorted or filtered files to first portion 120 for display to a user. FIG. 7 illustrates the steps to a particular method 170, which causes a list of documents related to the social security number of a particular patient that is the subject matter of the presently selected task to be generated and displayed. First, at step 172, a user selects documents button 149. Then, at step 174, method 170, which is associated with button 149, is executed. At step 176, a query of EIF database 80 is performed to generate a list of all electronic image files that include a unique patient identifier field having the same unique patient identifier as the patient who is the subject of the presently selected task. Then, at step 178, the list of electronic image files generated in step 176 is returned to task engine 24 for display in first portion 120 of GUI 90. In other embodiments, such as a particular one of methods 76 associated with view link 154, the electronic images, rather than a list of electronic image filenames, are automatically displayed in first portion 120 upon selection of the link or button.

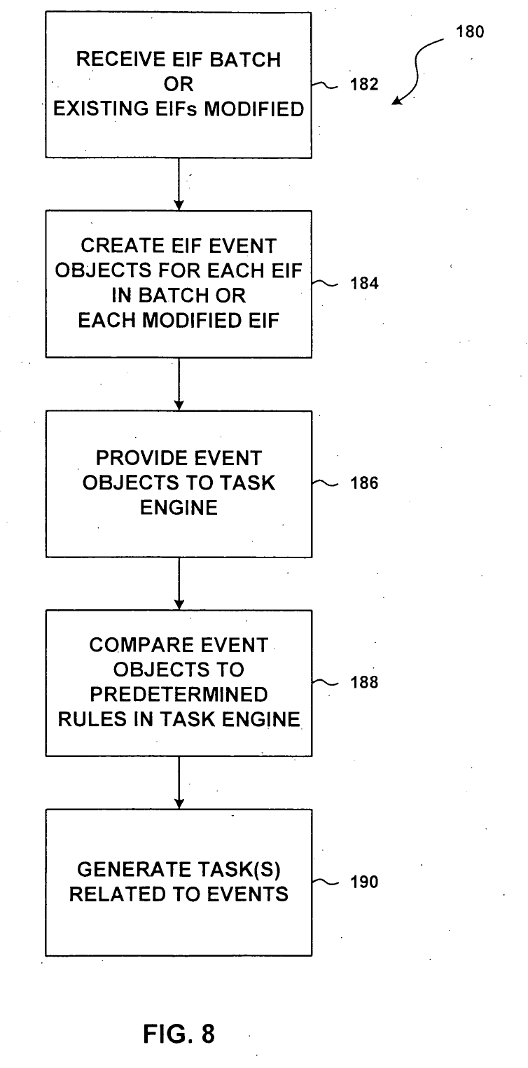

Another aspect of the present invention is a method 180 of generating tasks related to electronic image files. FIG. 8 illustrates the steps of method 180. First, at step 182, either EIF batch 26 or 32 containing one or more electronic image files is received by EDM 22 or one or more existing EIFs from EIF database 80 that have been modified are received by EDM 22. Then, at step 184, EIF event generator 74 creates an EIF event 78 for each of the electronic image files received either in EIF batch 26 and 32 or from EIF database 80. Next, at step 186, each EIF event 78 created in step 184 is sent to event queue 96 of task engine 24. Then, at step 188, each EIF event 78 in event queue 96 is compared to one or more predetermined rules in ruleset manager 98 of task engine 24. Finally, at step 190, task generation manager 102 and system task generation routine 104 generate tasks related to each EIF event 78 if they meet the conditions of one or more predetermined rules in ruleset manager 98.

The system and methods of the present invention help reduce the overall revenue cycle for billing processes that include electronic image files. By integrating an EDM to interact with tasking/workflow engines, better workflow capabilities for working tasks related to electronic image files are provided thereby reducing the amount of time it takes to work such tasks. By opening up an EDM to work with a tasking engine, documents are not lost and they are routed to the appropriate users for follow-up.

In one example of one application of the present invention, the system is used in the healthcare industry in a medical data management system to provide a user the capability to see all electronic image files related to a particular patient, specific types of images for a particular patient, and specific types of images for all patients. This type of functionality enhances the overall flow of information within the system thereby saving both time and money.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

1. A system for generating one or more tasks related to one or more electronic image files, said system comprising:
an electronic document manager including an electronic image file database for storing the electronic image files and an electronic image file event generator for generating electronic image file events related to the electronic image files; and
a task engine in communication with said electronic document management module for generating tasks related to the electronic image files based on the contents of said electronic image file events.

2. A system according to claim 1, wherein said task engine further comprises a task generator including an event manager for storing said electronic image file events, a ruleset manager including at least one predetermined set of rules, each of said rules having at least one predetermined condition, and a task generation manager for comparing the electronic image file events to said at least one predetermined set of rules and generating one or more tasks if the electronic image file events meet said at least one predetermined condition.

3. A system according to claim 1, wherein said task engine module further comprises predetermined task instructions for working each of the tasks generated that relate to the electronic image files.

4. A system according to claim 3, wherein said task instructions include a predetermined workflow.

5. A system according to claim 3, wherein said task instructions include means for linking to said electronic document manager.

6. A system according to claim 5, wherein said means for linking allow the electronic image files stored in said database to be viewed in said task engine.

7. A system according to claim 5, wherein said means for linking include a button control and a hypertext link.

8. A system according to claim 5, wherein said electronic document manager includes one or more method modules for sorting or filtering particular groups of electronic image files and said means for linking is used to execute said one or more method modules.

9. A system according to claim 1, wherein said task engine module includes a task list including said tasks relating to the electronic image files.

10. A method of generating one or more tasks related to one or more electronic image files stored in an electronic document manager, said method comprising the steps of:
creating one or more electronic image file events related to the electronic image files;
providing a predetermined set of rules, each of said rules having at least one predetermined condition;
comparing said one or more electronic image file events to said predetermined set of rules; and
creating one or more tasks if said one or more electronic image file events meets said at least one predetermined condition.

11. A method according to claim 10, wherein said one or more tasks include predetermined task instructions for working each of said one or more tasks.

12. A method according to claim 11, wherein said task instructions include a predetermined workflow.

13. A method according to claim 11, wherein said task instructions are adapted to link to said electronic document manager.

14. A system for generating one or more tasks related to one or more electronic image files, said system comprising:
an electronic document management module including an electronic image file database for storing the electronic image files and an electronic image file event generator submodule for generating electronic image file events related to the electronic image files; and
a task engine module in communication with said electronic document management module for generating tasks related to the electronic image files based on the contents of said electronic image file events, said task engine module including a task generation submodule including an event manager for storing said electronic image file events, a ruleset manager including at least one predetermined set of rules, each of said rules having at least one predetermined condition, and a task generation manager for comparing the electronic image file events to said at least one predetermined set of rules and generating one or more tasks if the electronic image file events meet said at least one predetermined condition.

15. A system according to claim 14, wherein said task engine module further comprises predetermined task instructions for working each of the tasks generated that relate to the electronic image files.

16. A system according to claim 14, wherein said task instructions include a predetermined workflow.

17. A system according to claim 14, wherein said task instructions include means for linking to said electronic document management module.

18. A system according to claim 14, wherein said means for linking allow the electronic image files stored in said database to be viewed in said task engine module.

19. A system according to claim 14, wherein said means for linking include a button control and a hypertext link.

20. A system according to claim 14, wherein said electronic document management module includes one or more method modules for sorting or filtering particular groups of electronic image files and said means for linking is used to execute said one or more method modules.

21. A system according to claim 14, wherein said task engine module includes a task list including said tasks relating to the electronic image files.

22. A computer readable medium in which is contained a program generating one or more tasks related to one or more electronic image files stored in an electronic document manager, the program comprising instructions that, when executed by a computer, perform the steps of:
creating one or more electronic image file events related to the electronic image files;
providing a predetermined set of rules, each of said rules having at least one predetermined condition;
comparing said one or more electronic image file events to said predetermined set of rules; and
creating one or more tasks if said one or more electronic image file events meets said at least one predetermined condition.

23. A computer readable signal according to claim 22, further comprising the step of working each of the tasks generated that relate to the electronic image files according to predetermined task instructions.

24. A computer readable signal according to claim 23, wherein said task instructions include a predetermined workflow.

25. A computer readable signal according to claim 22, wherein said task instructions include means for linking to the electronic document manager.
